(19) United States
(12) Patent Application Publication
(10) Pub. No.: US 2008/0039149 A1
(43) Pub. Date: Feb. 14, 2008

(54) KEY FOR A PORTABLE TERMINAL

(75) Inventors: Hyun-Jung JEONG, Seongnam-si (KR); Yoon-Hee Lee, Incheon (KR); Shin-Chul Kang, Seoul (KR); Yong-Wook Hwang, Suwon-si (KR); Young-Ki Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,492

(22) Filed: Aug. 8, 2007

(30) Foreign Application Priority Data
Aug. 8, 2006 (KR) 74769-2006

(51) Int. Cl. H04B 1/38

(52) U.S. Cl. 455/566

(57) ABSTRACT

Provided is a key for a portable terminal. The key includes a metallic case including a plated layer exposed to the outside of the portable terminal and an electro-forming layer formed on the inner side of the plated layer and a synthetic resin layer formed on the inner side of the electro-forming layer. The synthetic resin layer is formed on the inner side of the electro-forming layer by mounting the metallic case in a mold and performing insert injection. Since the key includes the electro-forming layer made of copper and the plated layer plated on the electro-forming layer on a surface for forming the exterior, it can be easily manufactured and can contribute to improvement of the exterior design of the portable terminal. Moreover, instead of plating the surface of the synthetic resin layer with nickel for forming the metallic case, the metallic case including the electro-forming layer made of copper and the plated layer is separately manufactured and insert injection is performed, thereby reducing the risk of causing allergy resulting from the use of nickel.

### PRIORITY

This application claims priority under 35 U.S.C. § 119 to an application entitled “Key For Portable Terminal” filed in the Korean Intellectual Property Office on Aug. 8, 2006 and assigned Serial No. 2006-74769, the contents of which are incorporated herein by reference.

### BACKGROUND OF THE INVENTION

1. Field of the Invention

The present invention relates generally to a portable terminal, and in particular, to a key for a portable terminal, which has a surface made of a metallic material.

2. Description of the Related Art

Generally, a portable terminal refers to an apparatus, which provides wireless communication between users or between users and service providers via a mobile communication base station. Various forms of service contents such as voice communication, a short message service, a mobile banking service, TV watching, an on-line game service, and an on-demand video service are provided to users using portable terminals.

The portable terminals may be classified into various types according to their appearance. For example, the portable terminals are classified into bar-type terminals, flip-type terminals, and folder-type terminals according to their appearance. In the bar-type terminal, input/output devices such as a communication circuit, a transmitting unit (or a mouthpiece), and a receiving unit (or an earpiece) are mounted in a single housing. In the flip-type terminal, a flip cover is mounted in the bar-type terminal. In the folder-type terminal, a pair of housings are opened and closed through rotation and input/output devices are properly arranged over the pair of housings. Recently, a sliding-type terminal has been developed to improve portability and convenience in use and satisfy various user preferences together with the folder-type terminal.

The portable terminals are equipped with a keypad, a microphone, and a camera lens as input devices. Among these input devices, the keypad is used not only for inputting character information such as a partner's call number and mail contents but also to call a function and a menu of the portable terminal, and to retrieve and activate stored information.

The keypad of the portable terminal includes a plurality of keys arranged on the portable terminal and a character or a symbol corresponding to a signal assigned to each of the keys is printed on the key.

Since the keypad of the portable terminal is an essential element for a function of the portable terminal and is exposed to the exterior of the portable terminal, it serves as an important part of the design of the portable terminal. Thus, in order to enhance the quality of the design of the portable terminal, quality enhancement in the exterior of the keypad is demanded.

In light of such a demand, keys that are made of a synthetic resin material and are plated with a metallic material have been suggested. When compared to keys made of only a synthetic resin material, the keys whose surfaces are plated with a metallic material have a superior anti-abrasion property and can easily acquire a metal-like gloss and thus, the keys are suitable for the exterior of the quality-enhanced portable terminal.

For the plated keys, a Acrylonitrile Butadiene Styrene copolymer (ABS) resin and a PolyCarbonate (PC) resin are injected and a metallic material such as nickel or chrome is plated. Then a plated layer is formed on the surface of the ABS resin, but it is not formed around the PC resin. The PC resin is a semi-permeable material through which light generated from a backlighting device installed in the portable terminal passes. Thus, a portion made of the PC resin forms a character or a symbol corresponding to a signal assigned to each key to allow a user to recognize the signal assigned to the key in a dark environment.

However, when keys are manufactured using double injection, after molding of a primary injection product, deformation of the primary injection product during secondary injection may cause a high proportion of defective keys. Moreover, although nickel is useful for improving manufacturing efficiency, it may cause an allergic reaction to users as well as operators if exposed directly to the users. Furthermore, a metallic cover may be manufactured in the shape of a cap combined with the exterior of the key using press forming, but the press forming method is not suitable for manufacturing a cover for a product if the product has a complex shape or exterior and for manufacturing a structure that transmits illumination of the backlighting device to the outside.

### SUMMARY OF THE INVENTION

It is, therefore, an object of the present invention to provide a key for a portable terminal, which has a structure capable of reducing the risk of causing an allergic reaction to operators and users and contributing to quality enhancement.

It is another object of the present invention to provide a key for a portable terminal, which is easy to manufacture and that contributes to improvement in the exterior design of the portable terminal.

According to an aspect of the present invention, there is provided a key for a portable terminal. The key includes a metallic case including a plated layer exposed to the outside of the portable terminal and an electro-forming layer formed in the inner side of the plated layer and a synthetic resin layer formed in the inner side of the electro-forming layer. The synthetic resin layer is formed in the inner side of the electro-forming layer by mounting the metallic case in a mold and performing an insert injection.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view illustrating a portable terminal having a key according to the present invention;

FIG. 2 is a perspective view illustrating a navigation key of the portable terminal shown in FIG. 1;

FIG. 3 is a cross-sectional view cut along a line S-S′ shown in FIG. 2; and

FIG. 4 is a view for explaining the structure of the key shown in FIG. 3.

### DETAILED DESCRIPTION OF THE PREFERRED EMBODIMENT

Hereinafter, a preferred embodiment of the present invention will be described with reference to the accompanying drawings. In the following description, a detailed description of known functions and configurations incorporated herein has been omitted for conciseness.

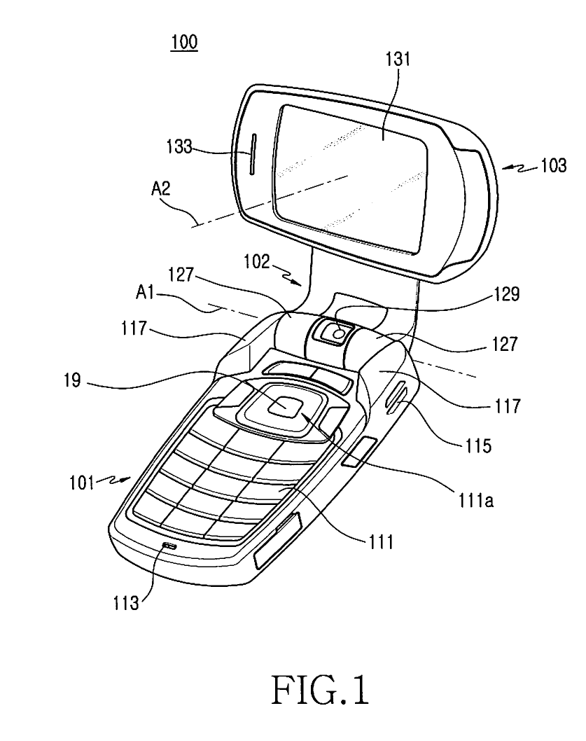

As shown in FIG. 1, a portable terminal 100 including a key according to the present invention includes a first housing 101, a second housing 102 that rotates with respect to a first hinge axis A1 towards or away from the first housing 101, and a hinge device (not shown) that rotatably couples the second housing 102 to the first housing 101.

If the portable terminal 100 is a general folder-type terminal, it may further include a display device and a receiving unit (or an earpiece) in the second housing 102. However, the portable terminal 100 according to the present invention further includes a third housing 103 coupled to the second housing 102 and the third housing 103 includes a display device 131. The third housing 103 rotates with respect to a second rotation axis A2 extending perpendicularly to the first hinge axis A1 and the second hinge axis A2 revolves around the first hinge axis A1 as the second housing 102 rotates with respect to the first hinge axis A1.

A keypad 111 and a transmitting unit 113 (or a mouthpiece) are installed in one face of the first housing 101 and a battery pack (not shown) is mounted on the other face of the first housing 101. Side hinge arms 117 are formed at both sides of an upper portion of the first housing 101 while facing each other. In some products, speaker devices 115 may be installed at both sides of the first housing 101. The speaker devices 115 may be installed adjacent to the side hinge arms 117.

The second housing 102 includes a center hinge arm 127 at its one end and the center hinge arm 127 is rotatably coupled between the side hinge arms 117. A hinge device that couples the first housing 101 and the second housing 102 is accommodated in the center hinge arm 127 and is connected to the first housing 101. The coupling of housings by a hinge device can be easily understood by those skilled in the art.

The second housing 102 serves as a connection member for connecting the third housing 103 to the first housing 101 and, although not shown in figures, a display device may be installed in the external side of the second housing 102 to display time, transmission/reception signal state, and remaining battery capacity. An opening can be formed in the center of the center hinge arm 127 for mounting of a camera unit 129.

The third housing 103 is coupled to the second housing 102 in opposition to the second housing 102 and rotates with respect to the second hinge axis A2. Another speaker device 133 is installed in at least one side of the display device 131 installed on one face of the third housing 103 to serve as a receiving unit.

When the second housing 102 is folded down to the first housing 101, the third housing 103 is interposed between the first housing 101 and the second housing 102 and the display device 131 faces one face of the first housing 101. Thus, the display device 131 is closed when the second housing 102 is folded down to the first housing 101, and the display device 131 is opened when the second housing 102 rotates and is opened.

The keys of the portable terminal 100 are manufactured by insert injection in which a metallic case is mounted in a mold and melted synthetic resin is injected. All the keys of the portable terminal 100 may be manufactured by insert injection, but a navigation key of the portable terminal 100 will be taken as an example for convenience of explanation.

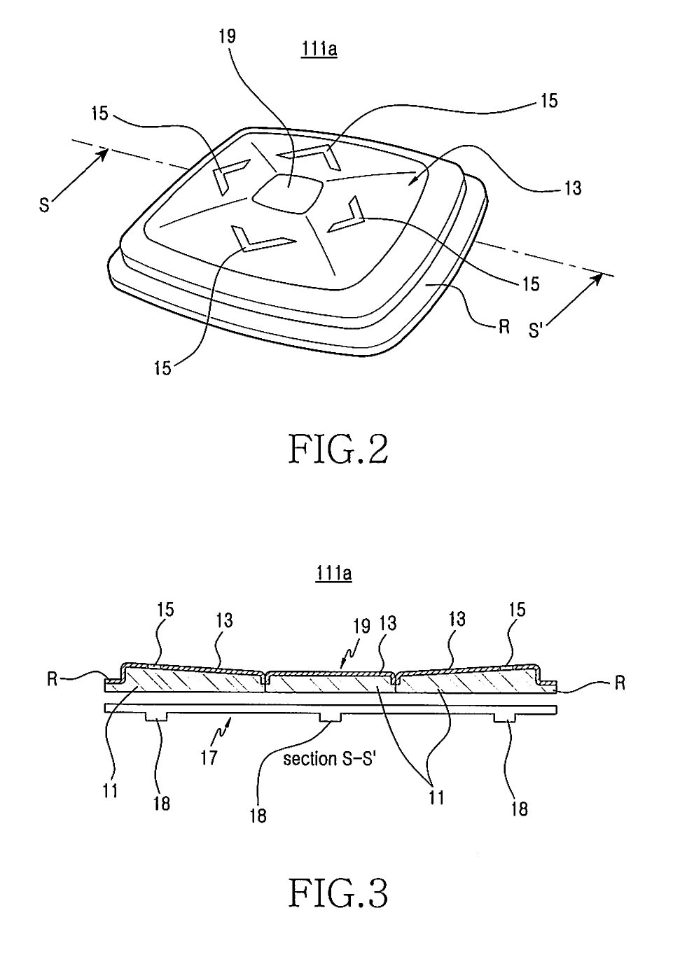

Referring to FIG. 2, a navigation key 111a allows input of four directions including up, down, left, and right directions and a printed unit 15 indicating each of the directions is formed on the surface of the navigation key 111a. A center key 19 assigned a signal like selection, confirmation, and input in addition to input of the four directions is arranged in the center of the navigation key 111a. Moreover, a support rib R protruding to the outside is formed along the edge of the navigation key 111a and is supported in the inner side of the first housing 101 of the portable terminal 100. Thus, the navigation key 111a is defined within the first housing 101.

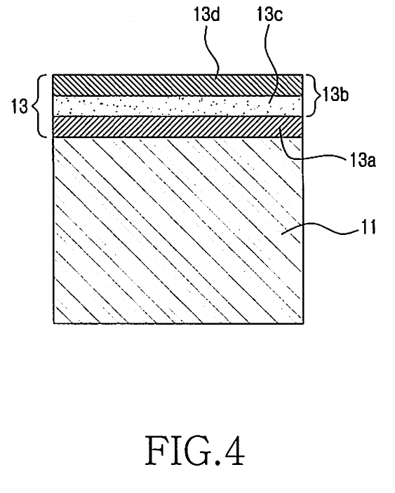

Referring to FIGS. 3 and 4, the external surface of the navigation key 111a is formed of a metallic case 13 and the inner surface of the navigation key 111a includes a synthetic resin layer 11 made of a synthetic resin material. Opening a portion of the metallic case 13 forms the printed unit 15 and it is a symbol indicating a direction for movement of a cursor or a menu. If keys for inputting numbers and characters are formed of the metallic case 13 and the synthetic resin layer 11, a number or a character corresponding to a signal assigned to each of the keys can be formed by opening a portion of the metallic case 13.

The metallic case 13 includes an electro-forming layer 13a of FIG. 4 and a plated layer 13b.

The electro-forming layer 13a is molded by performing electroplating and casting on the surface of a previously processed mold having a shape corresponding to the navigation key 111a using copper. If a plurality of keys are molded in the mold, a plurality of electro-forming layers 13a can be formed at the same time. An opened portion corresponding to the printed unit 15 has already been formed in the electro-forming layer 13a.

If the electro-forming layer 13a is formed to a thickness of 0.2-0.3 mm, it may be separated from the mold and be pressed to adjust its thickness according to the standards of a product or be polished to remove an unnecessary portion around the edge according to the shape of the product.

The plated layer 13b is formed by plating the pressed and the polished electro-forming layer 13a, thereby acquiring a surface having an anti-abrasion property and a metal-like gloss. The plated layer 13b can be formed by forming a first plated layer 13c on the external surface of the electro-forming layer 13a with an alloy of copper and tin, an alloy of copper, tin, and zinc, or a metal made of a palladium material and forming a second plated layer 13d on the first plated layer 13c with trivalent chromium.

If the navigation key 111a is completed on the condition that the exterior of the portable terminal can be formed only with the first plated layer 13c, it is not necessary to form the second plated layer 13d, but a gloss and various textures of the surface of the navigation key 111a can be implemented by forming the second plated layer 13d with trivalent chromium.

The metallic case 13 that is completed by plating the electro-forming layer 13a is mounted in the mold and insert injection is performed, thereby completing the navigation key 111a. Insert injection is a molding method in which a member made of a metallic material is mounted in a mold, melted synthetic resin is injected for the molding, and the member is fixed to an injection product along with the molding of the injection product.

A semi-permeable material or a transparent material is suitable for synthetic resin used for insert molding of the metallic case 13 to allow light generated from a backlighting device of a keypad to penetrate. The semi-permeable material or the transparent material can be PolyCarbonate (PC) resin.

The light generated from the backlighting device passes through the synthetic resin layer 11 and is emitted through the printed unit 15 of the metallic case 13. The user can recognize a signal assigned to each key with the aid of the light emitted through the printed unit 15 and manipulate a desired key in the dark environment.

A silicon pad 17 is attached under the navigation key 111a. More specifically, keys to be mounted on the portable terminal may be mounted on the silicon pad 17 and pressing protrusions 18 are formed under the silicon pad 17. The pressing protrusions 18 are formed in positions corresponding to the keys and if the user manipulates a key, a pressing protrusion in a position corresponding to the key manipulates a dome switch (not shown) to generate a corresponding signal.

As described above, the key for the portable terminal according to the present invention includes an electro-forming layer made of copper and a plated layer plated on the electro-forming layer on a surface for forming the exterior, thereby being easily manufactured and contributing to improvement of the exterior design of the portable terminal. Moreover, instead of plating the surface of a synthetic resin layer with nickel for forming a metallic case, a metallic case including an electro-forming layer made of copper and a plated layer is separately manufactured and insert injection is performed, thereby reducing the risk of causing allergy resulting from the use of nickel. Furthermore, since double injection of synthetic resin materials having different properties is not required, a defective proportion can be reduced and manufacturing efficiency can be improved.

While the present invention have been shown and described with reference to preferred embodiments thereof, it will be understood by those skilled in the art that various changes in form and details may be made therein without departing from the spirit and scope of the invention. For example, although a navigation key allowing input of four directions is taken as an example in the embodiment of the present invention, a key including a metallic case and a synthetic resin layer may be used for a general input key such a number input key or a character input key as well as a volume control key installed at a side of a terminal housing.

What is claimed is:

1. A key for a portable terminal, comprising:
a metallic case including a plated layer exposed to an outside of the portable terminal and an electro-forming layer formed on an inner side of the plated layer; and
a synthetic resin layer formed on an inner side of the electro-forming layer,
wherein the synthetic resin layer is formed on the inner side of the electro-forming layer by mounting the metallic case in a mold and performing insert injection.

2. The key of claim 1, wherein the plated layer is formed by plating an external side of the electro-forming layer with one of an alloy of copper and tin, an alloy of copper, tin, and zinc, and a palladium material.

3. The key of claim 1, wherein the plated layer includes a first plated layer formed by plating an external side of the electro-forming layer with one of an alloy and a palladium material.

4. The key of claim 1, wherein the electro-forming layer is manufactured with copper.

5. The key of claim 1, wherein at least one portion of the metallic case is opened and the opened portion is a character indicating a signal assigned to a corresponding key.

6. The key of claim 5, wherein the synthetic resin layer is made of a semi-permeable material through which at least one portion of a visual ray can pass.

7. The key of claim 1, wherein the metallic case includes two pairs of opened portions that are symbols indicating up, down, left, and right directions.

8. The key of claim 7, wherein the synthetic resin layer is made of a semi-permeable material through which at least one portion of a visual ray can pass.

9. The key of claim 1, wherein the synthetic resin layer is attached to a silicon pad.
